(19) United States
(12) Patent Application Publication
(10) Pub. No.: US 2018/0356946 A1
(43) Pub. Date: Dec. 13, 2018

(54) SCENE-MODE SWITCHING SYSTEM AND STATE CONFLICT DISPLAYING METHOD

(71) Applicant: Shih Ning CHOU, New Taipei City (TW)

(72) Inventor: Shih Ning CHOU, New Taipei City (TW)

(21) Appl. No.: 15/866,364

(22) Filed: Jan. 9, 2018

(30) Foreign Application Priority Data
Jun. 12, 2017 (TW) 106119456
Sep. 26, 2017 (TW) 106133006

(51) Int. Cl. G06F 3/0482; H04M 1/725; G06F 1/32; G06F 3/0484

(52) U.S. Cl. CPC G06F 3/0482; G06F 3/04847; G06F 1/3209; H04M 1/72533

(57) ABSTRACT

A state conflict displaying method executed by a mobile device is disclosed and including following steps of: enabling one of a plurality of preset scene modes, wherein a configuration of each scene mode respectively indicates a power state of connected electronic appliances; configuring the last enabled scene mode to have a highest priority, and moving it to a first rank upon a scene list; generating and transmitting control signal to control the electronic appliances according to the configuration of the scene mode having the highest priority; comparing the current power state of the electronic appliances with the configuration of each previously enabled scene mode; and, displaying the name of one of the electronic appliances when determining the electronic appliance has a power state conflict issue.

### BACKGROUND OF THE INVENTION

### Field of the Invention

The present invention relates to switching and displaying of scene modes, and especially to a scene-mode switching system and state conflict displaying method thereof.

### Description of Prior Art

Different electronic appliances (such as TVs, computers, audios, lights, etc.) respectively have their own power switch, and each of the electronic appliances generally needs respective control.

Multiple electronic appliances usually need to be turned on/off simultaneously when the user is performing specific activities such as watching movies or reading books. For example, a TV, a DVD player and an audio are turned on by the user for watching movies while the lights are turned off. But if the user wants to read, the TV, the DVD player and the audio are turned off by the user while the lights are turned on. The aforementioned apparatuses need to be respectively controlled by the user for different activities, which is thus troublesome.

To solve the above problem, a single remote controller is provided to simultaneously control operating modes of a number of electronic appliances based on the scene (such as a watching movie scene, a reading scene, etc.). For example, when the user wants to watch movies, the TV, the DVD player and the audio are automatically turned on and the light is automatically turned off through triggering “watching movies” scene by using the remote controller, thus complicated operation of various controls for various electronic appliances is eliminated.

However, different scenes may switch the same electronic appliance to different states. If multiple scenes are enabled simultaneously, the same electronic appliance may have a state conflict issue under different enabled scenes.

In view of this, it is important for the user to be able to simultaneously control multiple electronic appliances and know whether the electronic appliance is in a state conflict.

### SUMMARY OF THE INVENTION

The present invention mainly provides a scene-mode switching system and state conflict displaying method thereof to enable the user to simultaneously control the power state of the plurality of electronic appliances, and display the conflict alarm when the power state of the electronic appliance has conflict issue in the plurality of scene modes during switching the scene modes.

Accordingly, the present invention provides the state conflict displaying method mainly used for a mobile device and the plurality of electronic appliances connected to the mobile device, and the state conflict displaying method includes steps of: (a) enabling one of a plurality of preset scene modes, wherein a configuration of each scene mode respectively designates or relates to the preset power states of the plurality of electronic appliances; (b) configuring the scene mode enabled in step (a) to have a highest priority and moving the scene mode having the highest priority to a first rank on a scene list displayed by the mobile device; (c) generating and transmitting a control signal according to the configuration of the scene mode having the highest priority, wherein the control signal is used to control the power state of each of the electronic appliances; (d) comparing the current power state of each of the electronic appliances with the configuration of other scene modes previously enabled to determine whether any of the electronic appliances is facing a power state conflict issue; and (e) displaying a name or a related diagram of one or more of the electronic appliances on the mobile device when the one or more electronic appliance(s) are determined facing the power state conflict issue.

Accordingly, the present invention provides a scene-mode switching system including a controller connected to a plurality of electronic appliances; and an application program configured to be executed in a mobile device connected to the controller to perform actions of:

enabling one of a plurality of preset scene modes, wherein a configuration of each scene mode respectively designates a preset power state of the plurality of electronic appliances; configuring the enabled scene mode to have a highest priority and moving the scene mode having the highest priority to a first rank on a scene list displayed by the mobile device; generating and transmitting a control signal according to the configuration of the scene mode having the highest priority, wherein the controller controls the power state of each of the electronic appliances according to the control signal; comparing the current power state of each of the electronic appliances with the configuration of other scene modes previously enabled to determine whether any of the electronic appliances is facing a power state conflict issue; and displaying a name or a related diagram of one or more of the electronic appliances on the mobile device when the one or more electronic appliances are determined facing the power state conflict issue.

Compared with the prior art, the present invention may allow the user to simultaneously control the power states of the plurality of electronic appliances by switching the scene modes. Besides, when the user enables multiple scene modes and thus causes one or more of the electronic appliances facing the power state conflict issue in different enabled scene modes, the present invention may automatically display a state conflict message on the mobile device to remind the user. In this way, the present invention may manage the conflict issues and kindly remind the user about the conflict issues.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWING

One or more embodiments of the present invention are illustrated by way of example and not limitation in the figures of the accompanying drawings, in which like references indicate similar elements. These drawings are not necessarily drawn to scale.

FIG. 1 shows a structural diagram of a switching system according to a first embodiment of the present invention.

FIG. 2 shows a schematic diagram of the switching system according to the first embodiment of the present invention.

FIG. 3 shows a diagram of scene-mode switch pages according to the first embodiment of the present invention.

FIG. 4A shows a diagram of a scene-mode setting page according to the first embodiment of the present invention.

FIG. 4B shows a diagram of a scene-mode setting page according to a second embodiment of the present invention.

FIG. 5 shows a flowchart of setting scene modes according to the first embodiment of the present invention.

FIG. 6 shows a flowchart of displaying state conflicts according to the first embodiment of the present invention.

FIG. 7A shows a diagram of a first switching action according to the first embodiment of the present invention.

FIG. 7B shows a diagram of a second switching action according to the first embodiment of the present invention.

FIG. 7C shows a diagram of a third switching action according to the first embodiment of the present invention.

FIG. 7D shows a diagram of a fourth switching action according to the first embodiment of the present invention.

FIG. 8 shows a diagram of a scene-mode stack according to the first embodiment of the present invention.

FIG. 9A shows a first flowchart of displaying state conflicts according to a second embodiment of the present invention.

FIG. 9B shows a second flowchart of displaying state conflicts according to the second embodiment of the present invention.

FIG. 10 shows a diagram of a switching system according to the second embodiment of the present invention.

### DETAILED DESCRIPTION OF THE INVENTION

Reference will now be made to the drawing figures to describe the present disclosure in detail. It will be understood that the drawing figures and exemplified embodiments of present disclosure are not limited to the details thereof.

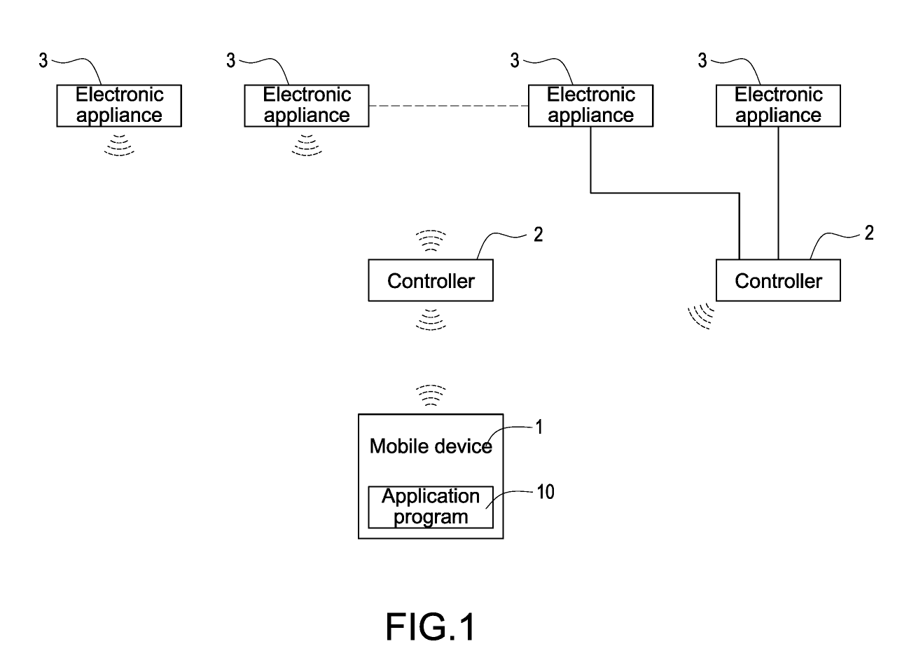

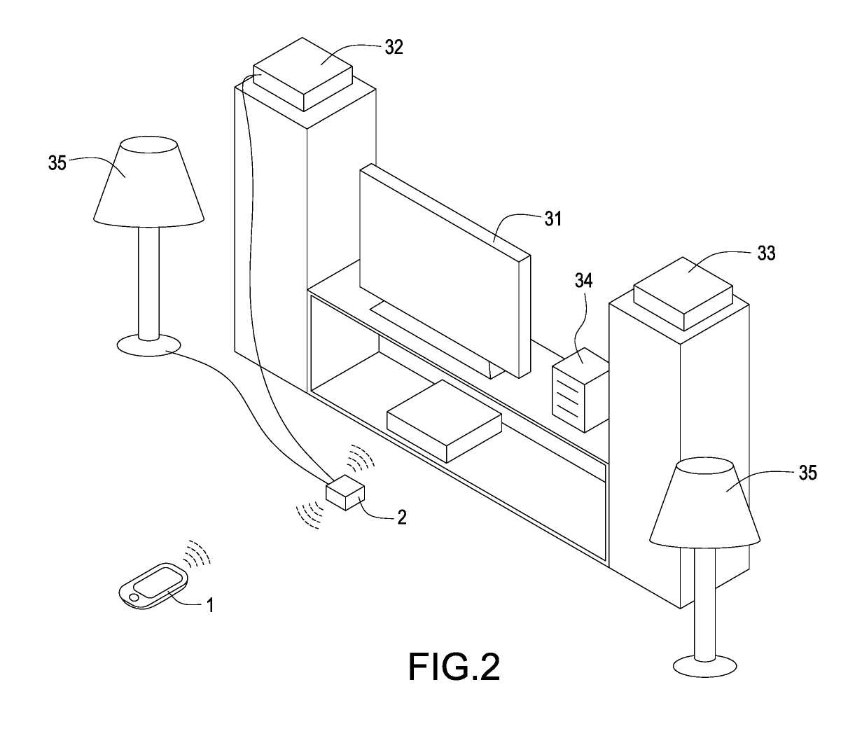

FIG. 1 shows a structural diagram of a switching system according to a first embodiment of the present invention, and FIG. 2 shows a schematic diagram of the switching system according to the first embodiment of the present invention. The present invention discloses a scene-mode switching system (referred to as a switching system hereinafter), and a state conflict displaying method adopted by the switching system (referred to as a displaying method hereinafter).

As shown in FIG. 1, the switching system of the present invention mainly includes a controller 2 and an application program (hereinafter referred to as “application”) 10 performed in a mobile device 1. The controller 2 is connected to an electronic appliance 3 nearby via a wired or wireless connection, and also connected to the mobile device 1 via a wireless connection. In the present invention, the application 10 is stored in a non-transitory storage unit (not shown) of the mobile device 1, and the mobile device 1 performs the application 10 to implement the displaying method of the present invention (described in detail below).

In an embodiment, the controller 2 is mainly connected to the mobile device 1 by a first wireless connection (such as Bluetooth transmission or Wi-Fi transmission), and connected to the electronic appliance 3 by a second wireless connection (such as radio frequency (RF) transmission or infrared ray (IR) transmission). The controller 2 wirelessly receives a control signal from the mobile device 1, converts an original format of the control signal into a compatible format supported by the second wireless connection, and transmits the control signal with the converted format to the electronic appliance 3 by the second wireless connection to correspondingly control the electronic appliance 3. In one embodiment, the control is, but not limited to, for turning on/turning off the power of the electronic appliance 3.

In another embodiment, the controller 2 may connect to mobile device 1 by the wireless connection, and may connect to the electronic appliance 3 by the wired connection (such as a transmission line). The controller 2 wirelessly receives the control signal from the mobile device 1, and directly transmits the control signal to the electronic appliance 3 through the transmission line, so as to correspondingly control the electronic appliance 3.

In another embodiment, the controller 2 is allocated with a power socket (not shown), and the power socket is used to connect a power plug (not shown) of the electronic appliance 3. In this way, the controller 2 may wirelessly receive the control signal from the mobile device 1, and then switches the on/off statuses of the power socket according to the received control signal to directly control the power-on/off of the electronic appliance 3.

In another embodiment, the mobile device 1 may be directly connected to the electronic appliance 3 by the wireless transmission to directly control the electronic appliance 3 by a control signal transmitted from the mobile device 1. In the embodiment, the controller 2 may be unnecessary.

A plurality of scene modes are preset in the application 10, and a configuration of each scene mode respectively designates the preset power states of the plurality of electronic appliances 3. A user may operate the mobile device 1 to perform the application 10, and control the application 10 to switch the scene modes (such as enabling or disabling each of the scene modes). When one of the scene modes is switched (enabled or disabled), the application 10 generates the control signal according to the configuration of the switched scene mode, and transmits the control signal to the controller 2 or the electronic appliance 3 by the mobile device 1.

As shown in FIG. 2, the electronic appliance 3 may be various household electrical appliances owned by the user, such as a television (hereinafter referred to as “TV”) 31, a DVD player 32, an amplifier 33, a loudspeaker 34, a table lamp 35, etc., but not limited. The user may operate the mobile device 1 and perform the application 10, so as to control the electronic appliance 3 through selecting one or more of the preset scenes.

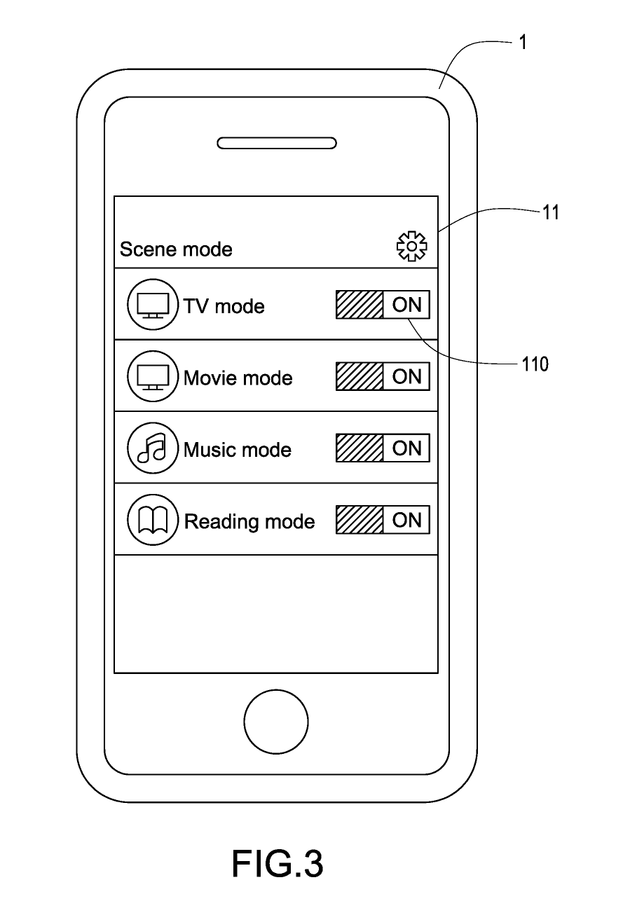

Please refer to FIG. 3, which shows a diagram of scene-mode switch pages according to the first embodiment of the present invention. After the mobile device 1 performs the application 10, a scene-mode switch page 11, which is provided by the application 10, is opened. In the scene-mode switch page 11, the user may switch states of the plurality of scene modes preset by the application 10.

As shown in FIG. 3, each scene mode respectively has a corresponding switch button 110 in the scene-mode switch page 11, and the user may trigger (or touch/press) the switch buttons 110 to enable/disable the corresponding scene modes. In the embodiment shown in FIG. 3, the scene modes are exemplified by a “TV mode”, a “movie mode”, a “music mode” and a “reading mode”. Besides, the application 10 of the present invention may further provide a function of adding additional scene modes, which allows the user to create necessary scene modes.

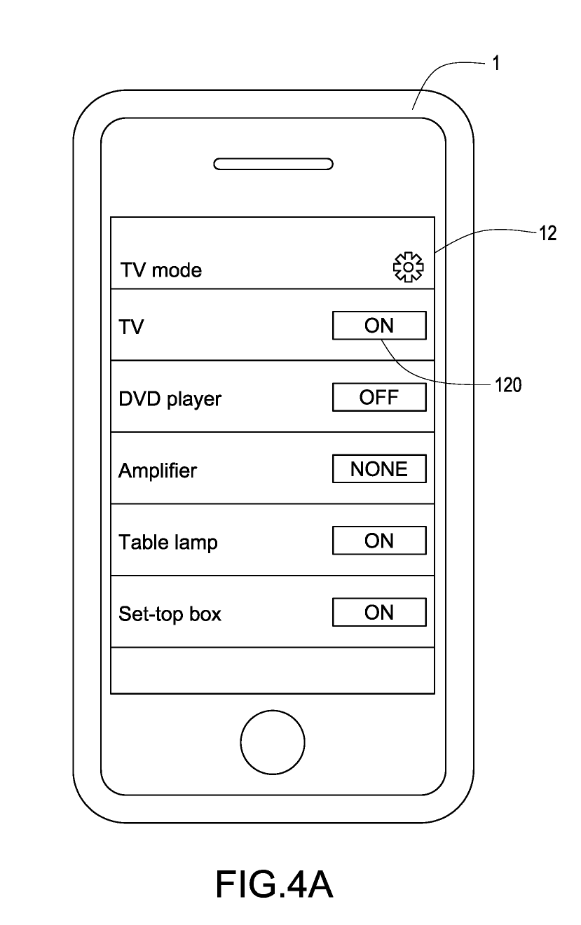

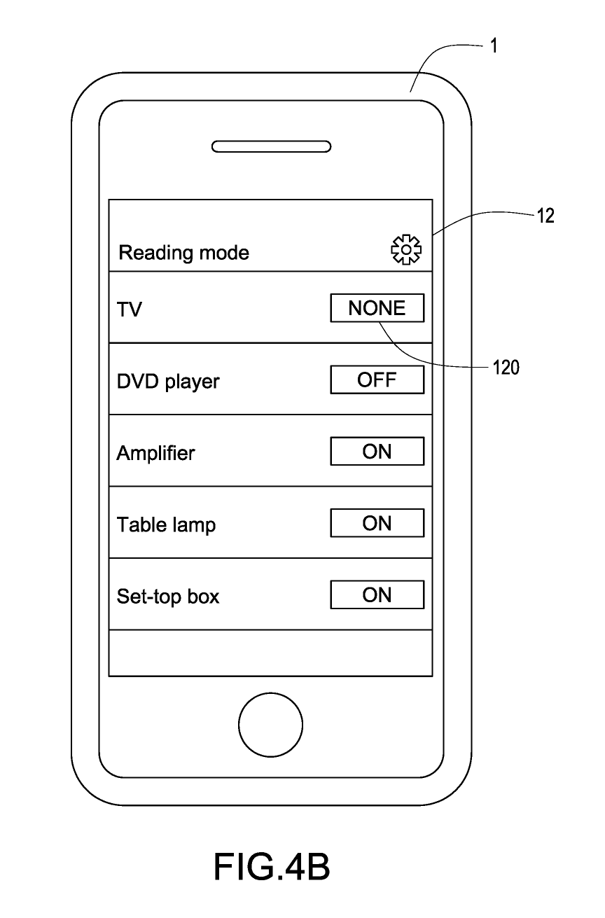

Please refer also to FIG. 4A and FIG. 4B, which show a diagram of a scene-mode setting page according to the first/second embodiment of the present invention, respectively. The user may further enable a scene-mode setting function of the application 10 (such as touching a setting icon on the upper right corner of the mobile device 1 in FIG. 3) to open a scene-mode setting page 12 provided by the application 10. In the scene-mode setting page 12, the user may set the electronic appliance(s) 3 associated with each of the scene modes, and also the power states of each of the electronic appliances 3.

Taking the “TV mode” as shown in FIG. 4A as an example, the TV mode is associated with multiple electronic appliances 3 such as a TV, a DVD player, an amplifier, a table lamp and a set-top box. The power states of the TV, the table lamp and the set-top box are set as “power turn-on (ON)”, the power state of the DVD player is set as “power turn-off (OFF)”, and the power state of the amplifier is set as “remaining in current state (NONE)”.

It should be noted that each electronic appliance 3 respectively has a correspondingly setting button 120 at the scene-mode setting page 12, and the user may set (or switch) the power state of each electronic appliance 3 by operating each setting button 120 (for example, touching or flipping the setting button 120). In an embodiment, the power states at least include power turn-on (ON), power turn-off (OFF) and remaining in current state (NONE), but not limited.

If the user sets up the power states shown in FIG. 4A as the configuration of the TV mode, when the user triggers the scene-mode switch page 11 and enables the TV mode, the application 10 generates and transmits the control signal to the controller 2 and/or the corresponding electronic appliance(s) 3 according to the configuration of the enabled TV mode. In this way, the application 10 may simultaneously turn on the TV 31, table lamp 35 and set-top box (not shown), turn off the DVD player 32, and remain the current power state of the amplifier 33 (i.e., the application 10 does not change the power state of the amplifier 33).

As the reading mode shown in FIG. 4B, the reading mode is set and associated with multiple electronic appliances 3 such as a TV, a DVD player, an amplifier, a table lamp and a set-top box. The power states of the amplifier, the table lamp and the set-top box are set as “power turn-on (ON)”, the power state of the DVD player is set as “power turn-off (OFF)”, and the power state of the TV is set as “remaining in current state (NONE)”.

If the user sets up the power states shown in FIG. 4B as the configuration of the reading mode, when the user triggers the scene-mode switch page 11 and enables the reading mode, the application 10 generates and transmits the control signal to the controller 2 and/or the corresponding electronic appliance(s) 3 according to the configuration of the enabled reading mode. In this way, the application 10 may simultaneously turn on the amplifier 33, the table lamp 35 and the set-top box (not shown), turn off the DVD player 32, and remain the current power state of the TV 31.

By operating the scene-mode setting page 12 mentioned above, the present invention allows the user to easily configure the one or more scene modes. By operating the scene-mode switch page 11 mentioned above, the present invention may allow the user to optionally enable/disable one or more scene modes.

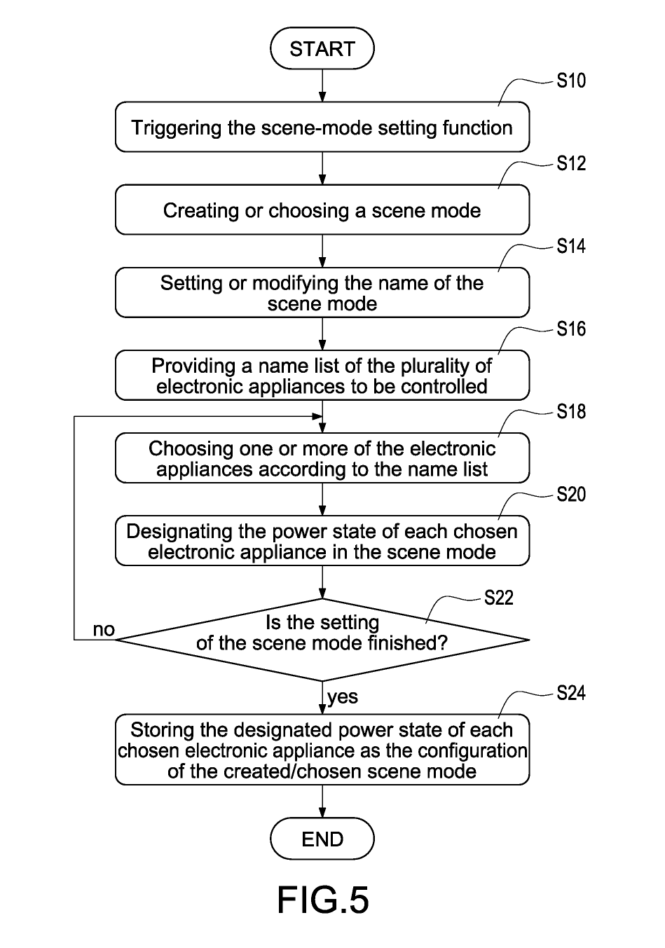

Refer to FIG. 5, which shows a flowchart of setting scene modes according to the first embodiment of the present invention. For creating new scene modes or modifying the configuration of the existing scene modes through the application 10, the user first needs to operate the mobile device 1 to trigger the scene-mode setting function of the application 10 (step S10).

Next, the user may create a new scene mode or choose an existing scene mode (step S12), and set or modify a name of the scene mode (step S14). In an embodiment, the user may create a new scene mode at the aforementioned scene-mode switch page 11, and set a name of the new scene mode. In another embodiment, the user may choose one of the plurality of existing scene modes displayed on a scene list of the aforementioned scene-mode switch page 11, and modifies the name of the chosen scene mode.

Afterward, the application 10 provides a name list of the plurality of electronic appliances 3 currently controllable (step S16). Specifically, the application 10 lists the name list of the plurality of electronic appliances 3 which are connected to the mobile device 1 and/or the controller 2 and also controllable by the application 10 through the scene-mode setting page 12. The user may choose one or more of the electronic appliances 3 for being included in the currently created/modified scene mode from the name list (step S18), and designates the power state of each of the chosen electronic appliances 3 in the scene mode (step S20).

After step S20, the application 10 determines whether the user finishes the setting of the scene mode (step S22). If the user has not finished the setting, the application 10 repeats performing step S18 and step S20 to allow the user continually choosing the electronic appliances 3 and designating the power state of the electronic appliances 3. If the user has finished the setting, the application 10 stores the one or more chosen electronic appliance(s) 3 and the designated power state of each chosen electronic appliance 3 as the configuration of the created/chosen scene mode (step S24). Afterward, when the user triggers the scene-mode switch page 11 of the application 10 and enables the above scene mode, the application 10 may generate the control signal according to the configuration of the enabled scene mode configured in step S24.

As mentioned above, the user may operate the mobile device 1 to switch the plurality of scene modes preset by the application 10. However, when the user simultaneously enables multiple scene modes, the power states of the electronic appliances 3 in the multiple enabled scene modes may have conflict issues. When the power states of the electronic appliances 3 have conflict issues, the present invention further provides the displaying method to remind the user to manage the conflict issues.

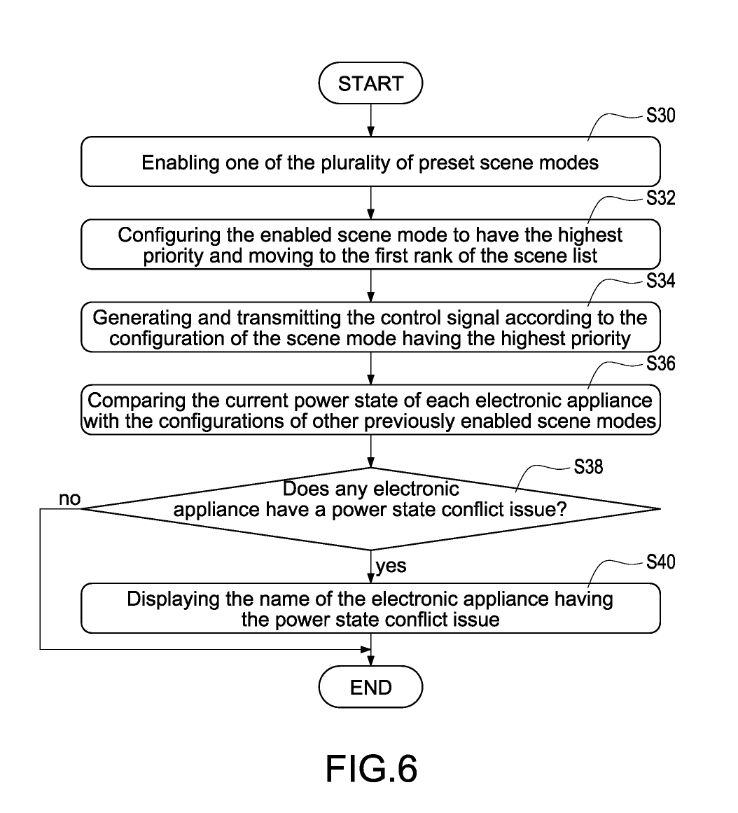

Refer to FIG. 6, which shows a flowchart of displaying state conflicts according to the first embodiment of the present invention. Specifically, the application 10 is stored and executed in a non-transitory storage memory (i.e., a non-volatile memory, such as a FLASH memory) of the mobile device 1, and records computer program codes that may be executable by a processor (not shown) of the mobile device 1. After the processor of the mobile device 1 executes the application 10, the computer program codes may be performed for executing each step shown in FIG. 6, so as to implement the displaying method of the present invention.

First, the application 10 receives external operations from the user to enable one of the plurality of preset scene modes (step S30). As mentioned above, the configuration of each scene mode respectively designates the preset power states of the plurality of electronic appliances 3. Next, the enabled scene mode is configured by the application 10 to have the highest priority, and moved to the first rank of the scene list displayed on the mobile device 1 as shown in FIG. 3 (step S32). In an embodiment, the application 10 moves the scene mode having the highest priority to the top of the scene list, but not limited. Next, the application 10 generates and transmits the control signal according to the configuration of the scene mode having the highest priority (step S34). In one embodiment, the mobile device 1 may transmit the control signal to the controller 2 or directly transmit the control signal to the corresponding electronic appliance(s) 3 to control the power state (such as power turn-on or power turn-off) thereof.

Specifically, in the embodiment, the user may simultaneously enable multiple scene modes. The application 10 may configure the last-enabled scene mode to have the highest priority, and generate the control signal according only to the configuration of the scene mode having the highest priority.

Next, the application 10 further compares the current power state of each electronic appliance 3 with the configurations of other previously enabled scene modes (step S36), so as to determine whether the power states of the electronic appliances 3 have conflict issues (step S38).

For example, if the user enables a first scene mode (the power state of TV in the first scene mode is ON), the application 10 generates the control signal of “turning on TV”. Next, the user further enables a second scene mode (the power state of TV in the second scene mode is OFF), the application 10 generates the control signal of “turning off TV”. After the comparison in step S36 mentioned above, the application 10 further determines whether the conflict issue exists between the current power state (OFF) of the TV and the power state configured in the first scene mode in step S38.

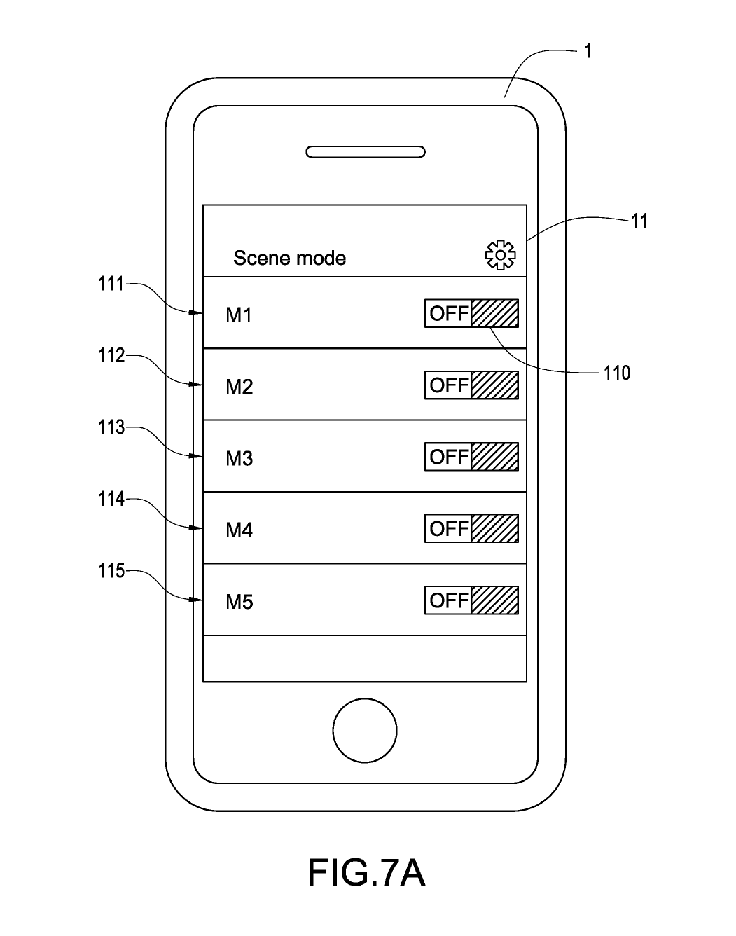

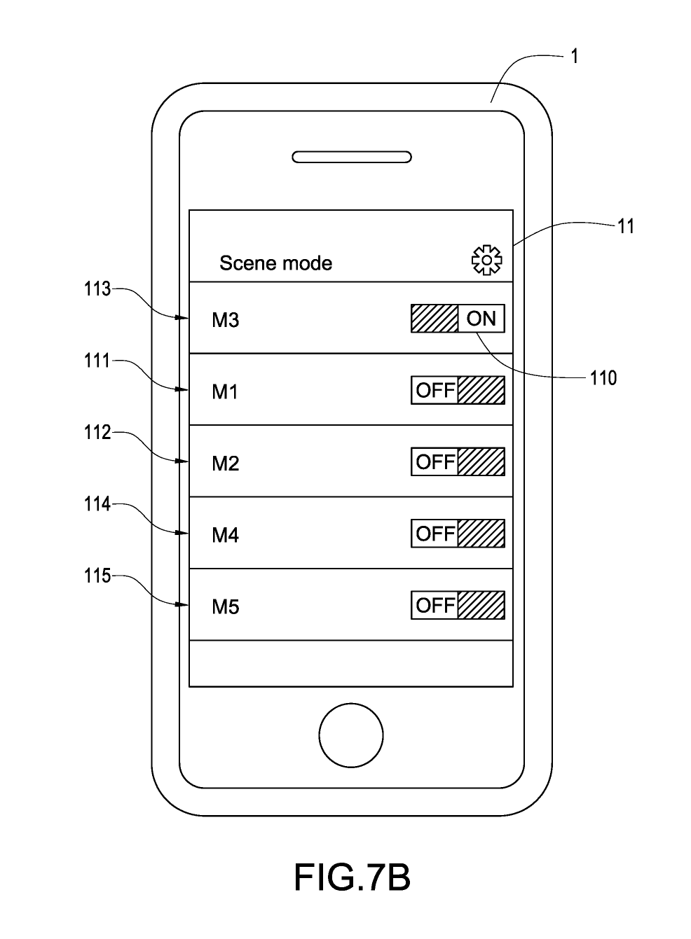

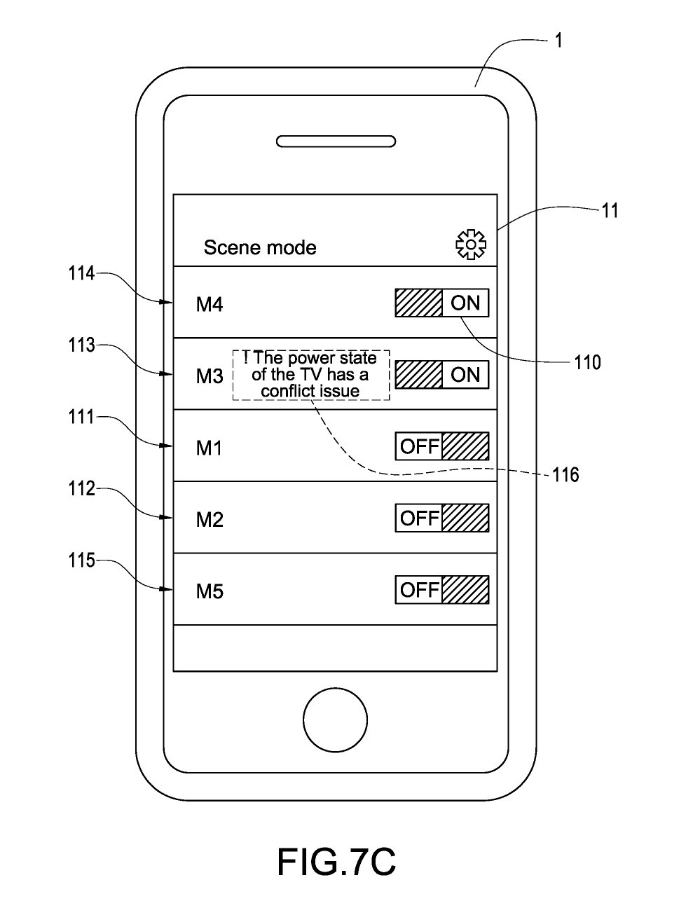

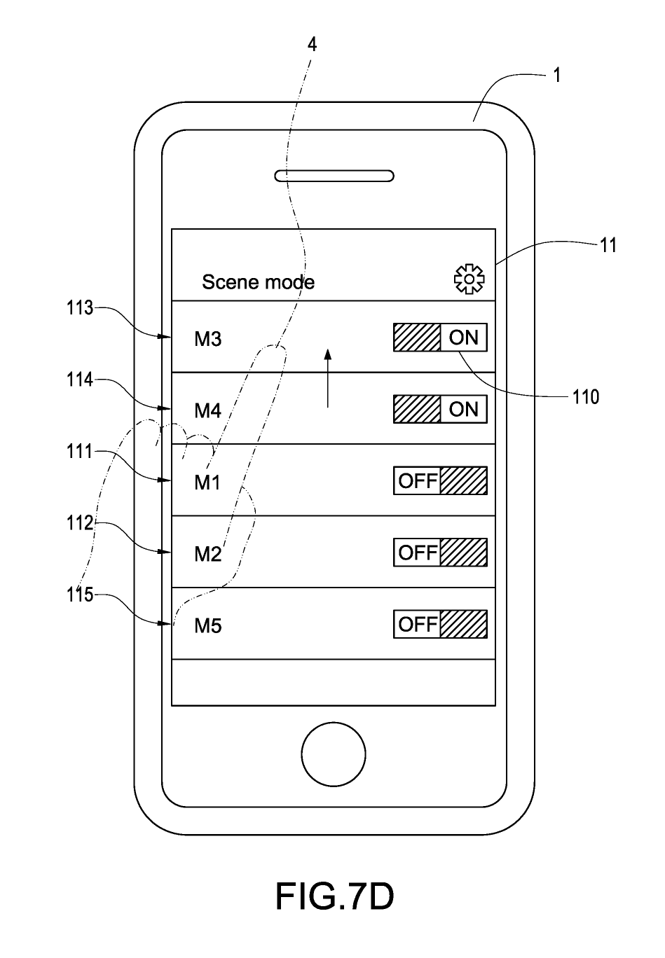

If determining in step S38 that the electronic appliance 3 has the power state conflict issue, the application 10 displays the name of the electronic appliance 3 on the mobile device 1 (step S40). For example, the application 10 may display a state conflict message 116 as shown in FIG. 7C on the scene-mode switch page 11. In particular, if one of the electronic appliances 3 has the power state conflict issue, the application 10 displays the state conflict message 116 on a column of the scene list corresponding to another scene mode that conflicts with the scene mode having the highest priority (as the example of FIG. 7C, a scene mode M3 conflicts with a scene mode having the highest priority (M4), so the application 10 displays the state conflict message 116 on the column corresponding to the scene mode M3)

In another embodiment, if an electronic appliance 3 having the power state conflict issue exists, the application 10 may also display the state conflict message 116 on a column of the scene list corresponding to the scene mode having the highest priority, wherein the state conflict message 116 may include the name of the electronic appliance 3 having the conflict issue, and also the name of the scene mode that conflicts with the scene mode having the highest priority. However, the above descriptions are just embodiments, not intended to narrow down the scope of the present invention.

Please refer also to FIG. 7A to FIG. 7D, which show a diagram of a first to fourth switching action according to the first embodiment of the present invention, respectively. The following descriptions are set forth in company with FIG. 7A to FIG. 7D for describing the actions of the application 10 of the present invention when multiple scene modes are simultaneously enabled.

As shown in FIG. 7A, in the embodiment, the application 10 is preset with a first scene mode 111 (such as M1), a second scene mode 112 (such as M2), a third scene mode 113 (such as M3), a fourth scene mode 114 (such as M4) and a fifth scene mode 115 (such as M5). Besides, the power states of the aforementioned scene modes 111-115 in FIG. 7A are previously set as disabled (OFF).

As shown in FIG. 7B, once the user touches or flips the switch button 110 corresponding to the third scene mode 113 to enable the third scene mode 113, the application 10 then configures the third scene mode 113 to have the highest priority and moves the third scene mode 113 to the first rank of the scene list. Besides, the application 10 generates and transmits the corresponding control signal according to the configuration of the third scene mode 113. Under this circumstance, each electronic appliance 3 may switch its own power state thereof according to the configuration of the third scene mode 113.

Next, as shown in FIG. 7C, the user touches or flips the switch button 110 corresponding to the fourth scene mode 114 to enable the fourth scene mode 114, and application 10 then configures the fourth scene mode 114 to have the highest priority instead of the third scene mode 113 (i.e., the third scene mode 113 no longer have the highest priority anymore). The application 10 then moves the fourth scene mode 114 to the first rank of the scene list, namely a priority rank of the third scene mode 113 is lower than and following that of the fourth scene mode 114. Besides, the application 10 generates and transmits the corresponding control signal according to the configuration of the fourth scene mode 114. Under this circumstance, each electronic appliance 3 may switch its own power state thereof according to the configuration of the fourth scene mode 114.

In the embodiment, one of the electronic appliances 3 has different power state configurations in the third scene mode 113 and the fourth scene mode 114 respectively. For example, the TV 31 may be configured to turn on in the third scene mode 113 and configured to turn off in the fourth scene mode 114.

After the fourth scene mode 114 is enabled, the application 10 may generate the control signal, and control the power state of the TV 31 to be power turn-off according to the configuration of the fourth scene mode 114. Next, the application 10 compares the current power state of the TV 31 (which is power turn-off) with the configuration of the third scene mode (M3) 113 (which is power turn-on), and determines that the TV 31 has a power state conflict issue after the comparison. Therefore, the application 10 further displays the state conflict message 116 on the mobile device 1 to remind the user, and allow the user to manage the conflict issue.

In an embodiment, the application 10 displays the state conflict message 116 on the scene-mode switch page 11, but not limited.

In an embodiment, the state conflict message 116 contains the name of the electronic appliance 3 having the power state conflict issue.

In an embodiment, the scene list includes multiple columns respectively corresponding to the plurality of scene modes, and the state conflict message 116 is displayed on the column corresponding to the scene mode that conflicts with the scene mode having the highest priority. For example, in the embodiment shown in FIG. 7C, the state conflict message 116 indicates “the power state of the TV has a conflict issue” and the message is displayed on a corresponding column of the third scene mode (M3) 113. In this way, it is very convenient for the user to directly know which scene mode previously enabled has conflict with the last enabled scene mode (i.e, the scene mode having the highest priority), and know which of the electronic appliances 3 has the conflict issue.

In one embodiment, the application 10 may determine that one of the electronic appliances 3 connected with the mobile device 1 has the conflict issue once the current power state of the electronic appliance 3 differs from the power state configured by any of the previously enabled scene modes.

It should be noted that the aforementioned power states may include power turn-on (ON), power turn-off (OFF) and remaining in current power state (NONE). If the power state of the electronic appliance 3 configured in the scene mode having the highest priority is remaining in current power state (NONE), the application 10 will not determine that the electronic appliance 3 has a conflict issue even if the current power state of the electronic appliance 3 differs from the power state of the electronic appliance 3 configured by other previously enabled scene modes.

In another embodiment, the application 10 determines that the electronic appliance 3 has a conflict issue if the current power state of any one of the electronic appliances 3 connected to the mobile device 1 is power turn-on, and the power state of that is configured as power turn-off in any one of the previously enabled scene modes.

In another embodiment, the application 10 determines that the electronic appliance 3 has a conflict issue if the current power state of any one of the electronic appliances 3 connected to the mobile device 1 is power turn-off, and the power state of that is configured as power turn-on in any one of the previously enabled scene modes.

As shown in FIG. 7D, the application 10 may configure the last enabled scene mode as the scene mode having the highest priority. However, the user 4 may operate the scene-mode switch page 11 of the application 10 to directly modify the order of the plurality of enabled scene modes by a finger or a touch pen.

For example, in the embodiment shown in FIG. 7D, the user 4 moves the third scene mode 113 to the first rank of the scene list through his finger. In this way, the application 10 re-configures the third scene mode 113 to have the highest priority (i.e., the fourth scene mode 114 no longer has the highest priority anymore), then regenerates and transmits the control signal according to the configuration of the third scene mode 113.

By using the technical solutions mentioned above, the user may easily modify the order of the plurality of enabled scene modes (i.e., modifying the priorities), so as to manage the power state conflict issues of the plurality of electronic appliances 3, which is very convenient.

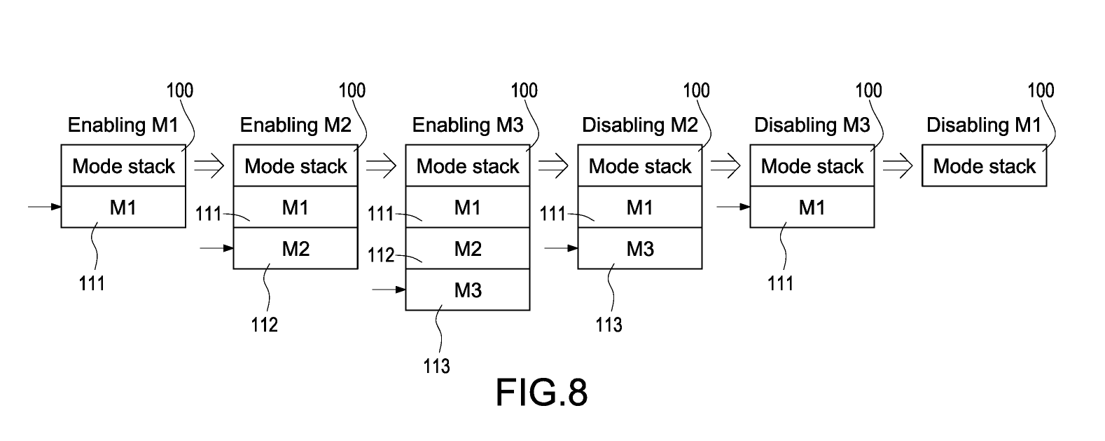

Please refer to FIG. 8, which shows a diagram of a scene-mode stack according to the first embodiment of the present invention. The application 10 has a mode stack 100, and all the enabled scene modes are sequentially added to the mode stack 100. Specifically, the application 10 adds the last enabled scene mode to the top of the mode stack 100, configures the scene mode at the top of the mode stack 100 as the scene mode having the highest priority, and moves the scene mode at the top of the mode stack 100 to the first rank of the scene list.

As shown in FIG. 8, after the user enables first scene mode 111, the application 10 adds the first scene mode 111 to the mode stack 100. Under this circumstance, no other scene mode is in the mode stack 100 (i.e., other scene modes are all disabled), and thus the first scene mode 111 is at the top of the mode stack 100. In other words, the first scene mode 111 has the highest priority and the application 10 generates and transmits the control signal according to the configuration of the first scene mode 111.

Afterward, the user enables the second scene mode 112, and then the application 10 adds the second scene mode 112 to the mode stack 100. Under this circumstance, the second scene mode 112 is stacked on the first scene mode 111 and at the top of the mode stack 100, which causes the second scene mode 112 replacing the first scene mode 111 and becoming the scene mode having the highest priority. After that, the application 10 regenerates and retransmits the control signal according to the configuration of the second scene mode 112.

After the user enables the third scene mode 113, the application 10 adds the third scene mode 113 to the mode stack 100. Under this circumstance, the third scene mode 113 is stacked on the second scene mode 112 and at the top of the mode stack 100, which causes the third scene mode 113 replacing the second scene mode 112 and becoming the scene mode having the highest priority. After that, the application 10 regenerates and retransmits the control signal according to the configuration of the third scene mode 113.

Further, when the user disables the second scene mode 112, the application 10 removes the second scene mode 112 from the mode stack 100. In the embodiment, the removed second scene mode 112 does not have the highest priority thus the application 10 will not regenerate the control signal. However, if the current power state of any one of the electronic appliances 3 differs from the configuration of the second scene mode 112 and causes a conflict issue, the conflict issue will be obviated after the second scene mode 112 is disabled, and thus the application 10 will cancel displaying the state conflict message.

Next, when the user disables the third scene mode 113, the application 10 removes the third scene mode 113 from the mode stack 100. In the embodiment, the removed third scene mode 113 has the highest priority thus the application 10 will configure the scene mode currently at the top of the mode stack 100 (i.e., the first scene mode 111) to have the highest priority, and performs a restoration operation to part or all of the electronic appliances 3 according to the removed third scene mode 113 (detailed described in the following), and regenerate the control signal according to the configuration of the first scene mode 111, so as to modify the power state of each electronic appliance 3 according to the configuration of the first scene mode 111. Similarly, the application 10 will again determine whether the current power state of each electronic appliance 3 has a conflict issue or not.

Next, when the user disables the first scene mode 111, the application 10 removes the first scene mode 111 from the mode stack 100, and performs the restoration operation to part or all of the electronic appliances 3 according to the removed first scene mode 111. Under this circumstance, no scene mode exists in the mode stack 100 anymore, which means all scene modes in the application 10 have been disabled.

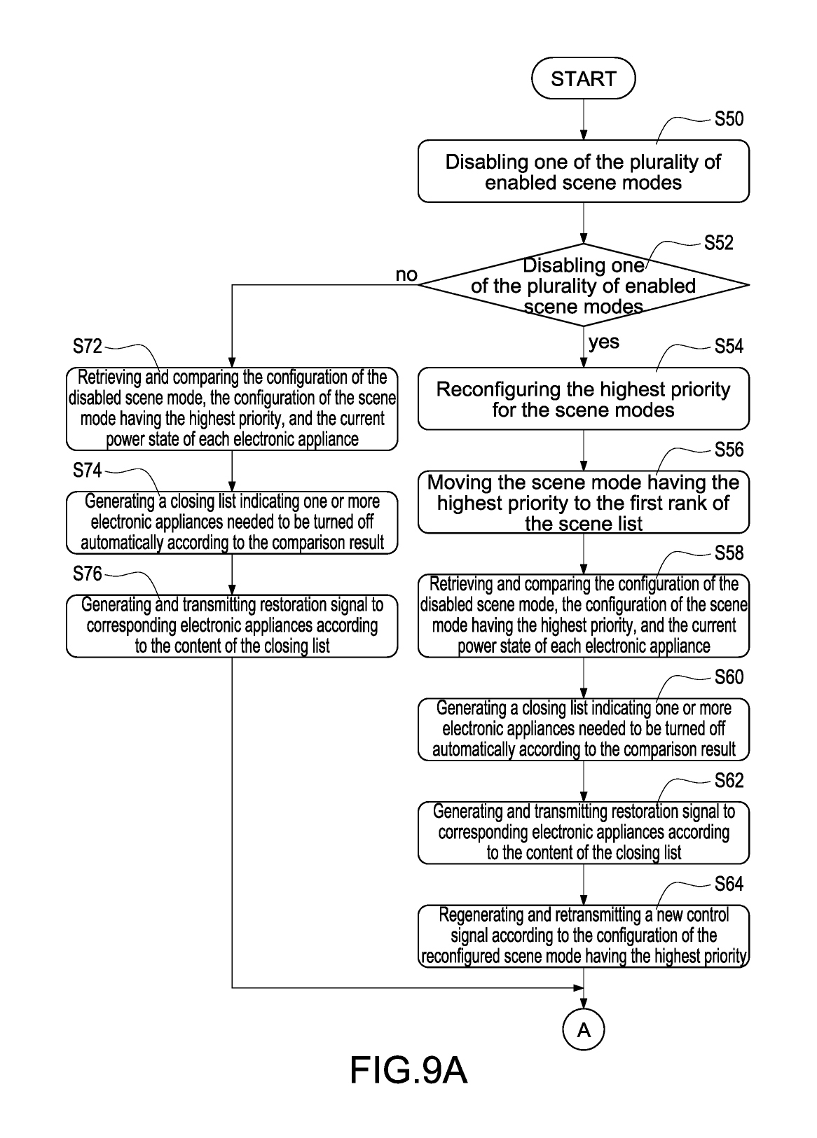

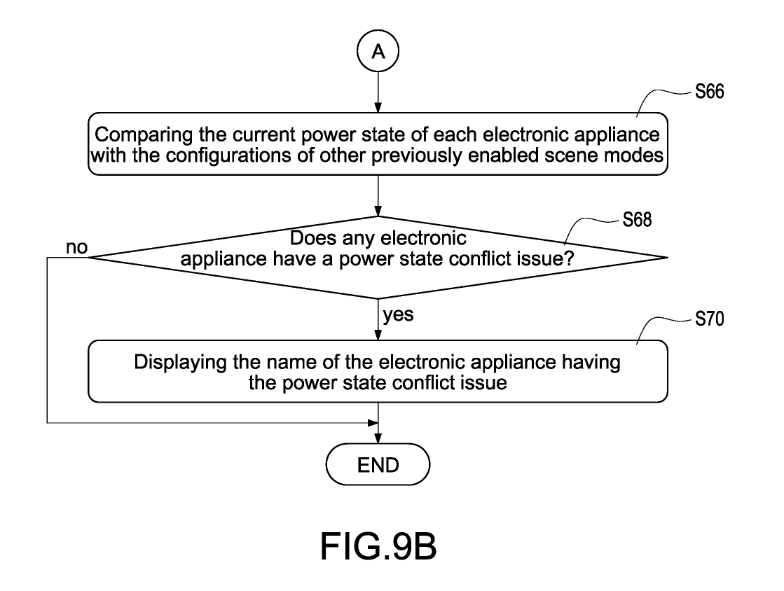

Please refer to both FIG. 9A and FIG. 9B, wherein FIG. 9A shows a first flowchart of displaying state conflicts according to a second embodiment of the present invention and FIG. 9B shows a second flowchart of displaying state conflicts according to the second embodiment of the present invention. FIG. 9A and FIG. 9b are describing the operation of the application 10 of the present invention when any one of the previously enabled scene modes is disabled.

Specifically, the application 10 receives external operations from the user to disable one of the plurality of enabled scene modes (step S50). Next, the application 10 determines whether the disabled scene mode has the highest priority (step S52). Specifically, the application 10 in step S52 is to determine whether the disabled scene mode is the last enabled scene mode or not (i.e., whether the disabled scene mode is the scene mode at the top of the mode stack 100).

If the disabled scene mode has the highest priority, the application 10 removes the disabled scene mode from the mode stack and reconfigures the highest priority for the scene modes remained in the mode stack (step S54). Specifically, the application 10 reconfigures the scene mode at the top of the mode stack 100 to have the highest priority. Next, the application 10 moves the scene mode having the highest priority to the first rank of the scene list (step S56),

In this embodiment, the application 10 respectively retrieves the configuration of the disabled scene mode, the configuration of the scene mode having the highest priority, and the current power state of each electronic appliance 3, and performs comparison simultaneously with the configuration of the disabled scene mode, the configuration of the scene mode having the highest priority, and the current power state of each electronic appliance 3 (step S58). Further, the application 10 generates a closing list according to the comparison result of the step S58 (step S60). In this embodiment, the closing list indicates one or more electronic appliances 3 that are necessary to be automatically turned off through the application 10.

If the aforementioned closing list does indicate one or more electronic appliances 3, the application 10 generates corresponding restoration signal according to the content of the closing list, and transmits the generated restoration signal to the corresponding one or more electronic appliances 3 (step S62). Therefore, the power state of the corresponding one or more electronic appliances 3 are automatically turned off through the restoration signal. On the other hand, if the closing list is null, the aforementioned step S62 will be omitted.

For example, the power state of an electronic appliance (such as D1) configured in the disabled scene mode (such as M1) is power turn-on (ON), the current power state of D1 is ON, and the power state of D1 configured in the scene mode having the highest priority (such as M2) is power turn-off (OFF), i.e., turning off the power state of D1 automatically will not cause a conflict issue with M2. Under this circumstance, the application 10 may list D1 in the closing list, and generates the restoration signal aimed at D1, and then turns off the power state of D1 automatically in the step S62.

For another example, the power state of an electronic appliance (such as D2) configured in the disabled scene mode (such as M1) is power turn-off (OFF), and the user once turned on the power state of D2 through other interfaces or controllers (i.e., the current power state of D2 differs from the power state of D2 configured in M1), and the power state of D2 configured in the scene mode having the highest priority (such as M2) is remaining in current power state (NONE) or power turn-off (OFF), i.e., turning off the power state of D2 will not cause a conflict issue with M2. Under this circumstance, the application 10 may list D2 in the closing list, and generates the restoration signal aimed at D2, and then turns off the power state of D2 automatically in the step S62.

Next, the application 10 regenerates and retransmits a new control signal according to the configuration of the reconfigured scene mode that has the highest priority (step S64), so as to correspondingly modify the power state of the multiple electronic appliances 3 according to the configuration of the scene mode currently having the highest priority.

It should be mentioned that the application 10 already considers the configuration of the scene mode having the highest priority while generating the closing list at the step S60. As a result, when generating the control signal in the step S64, the application 10 may avoid the same electronic appliance(s) 3 from being controlled repeatedly.

For example, if the power state of an electronic appliance (such as D3) configured in the disabled scene mode (such as M1) is power turn-off (OFF), and the user once turned on the power state of D3 through other interfaces or controllers (i.e., the current power state of D3 differs from the power state of D3 configured in M1). Under this circumstance, the application 10 may list D3 in the closing list when disabling M1. However, if the power state of D3 configured in the scene mode currently having the highest priority is power turn-on (ON), the application 10 will consider: (1) may D3 has a conflict issue with the scene mode having the highest priority if automatically turning off the power state of D3; (2) D3 will be controlled repeatedly and resources will be wasted if automatically turning off the power state of D3 according to the restoration signal in the step S62 and then turning on the power state of D3 according to the control signal in the step S64

In other words, if the amount of the multiple electronic appliances 3 is ten (such as D1 to D10), and the application 10 automatically turns off the power state of D1, D2, and D3 through the restoration signal in the step S62, the application 10 will not perform any further control on D1, D2, and D3 through the control signal in the step S64.

If the application 10 determines in the step S52 that the disabled scene mode is not the scene mode having the highest priority, it is unnecessary to reconfigure the highest priority for the scene modes. Under this circumstance, the application 10 directly retrieves and compares the configuration of the disabled scene mode, the configuration of the scene mode having the highest priority, and the current power state of each electronic appliance 3 (step S72). Also, the application 10 generates the closing list according to the comparison result of the step S72 that indicates the one or more electronic appliances 3 which are necessary to be turned off automatically (step S74).

If the closing list does indicate one or more electronic alliances 3, the application 10 generates corresponding restoration signal according to the content of the closing list, and transmits the generated restoration signal to the corresponding one or more electronic appliances 3 (step S76), so as to automatically turn off the power state of the corresponding one or more electronic appliances 3. On the other hand, if the closing list is null, the aforementioned step S76 will be omitted.

Specifically, the step S72 to the step S76 are identical or similar to the aforementioned step S58 to step S62. In this embodiment, the disabled scene mode is not the scene mode having the highest priority, so the application 10 doesn't need to regenerate and retransmit a new control signal after the step S76 (i.e., the aforementioned step S64 is omitted in this circumstance).

According to the aforementioned steps, the application 10 may control the power state of the multiple electronic appliances 3 connected to the mobile device 1 once the user enables/disables any one of the scene modes. In this way, the operation of the electronic appliances 3 may match the scene mode most urgently needed by the user, i.e., the scene mode having the highest priority.

After the step S64 or the step S76, the application 10 compares the current power state of each electronic appliance 3 with the configurations of other previously enabled scene modes (step S66), so as to determine whether any electronic appliance 3 has a power state conflict issue after one of the scene modes is disabled in the step S50 (step S68).

For example, if the power state of the TV configured in the enabled first scene mode conflicts with that of the TV configured in the enabled second scene mode, the conflict issue of the TV will be obviated after the application 10 disables the second scene mode in the step S50.

After step S68, the application 10 may display the name of one of the electronic appliances 3 on the mobile device 1 once determining that the electronic appliance 3 has the power state conflict issue (step S70). Specifically, the application 10 may display, on the mobile device 1, the name of the electronic appliance 3, the serial number of the electronic appliance 3, the diagram related to the electronic appliance 3, or any information for the user to confirm the identity of the electronic appliance 3, not limited to only the name of the electronic appliance 3.

For ease of understanding, the following embodiment further describes the operation of the application 10 when multiple scene modes are enabled/disabled.

Refer to the following table, the configuration of four scene modes are listed.

| | electronic appliance | | | |
|---|---|---|---|---|
| | first | second | third | fourth |
| | electronic | electronic | electronic | electronic |
| | appliance | appliance | appliance | appliance |
| scene mode | (D1) | (D2) | (D3) | (D4) |
| first scene mode | ON | ON | NONE | ON |
| (M1) | | | | |
| second scene | ON | NONE | ON | ON |
| mode (M2) | | | | |
| third scene mode | NONE | OFF | ON | NONE |
| (M3) | | | | |
| fourth scene mode | OFF | ON | NONE | OFF |
| (M4) | | | | |

In the embodiment of the above table, the configuration of M1 indicates: “power turn-on (ON) for D1, power turn-on (ON) for D2, remaining in current power state (NONE) for D3, power turn-on (ON) for D4”. The configuration of M2 indicates: “power turn-on (ON) for D1, remaining in current power state (NONE) for D2, power turn-on (ON) for D3, power turn-on (ON) for D4”. The configuration of M3 indicates: “remaining in current power state (NONE) for D1, power turn-off (OFF) for D2, power turn-on (ON) for D3, remaining in current power state (NONE) for D4”. The configuration of M4 indicates: “power turn-off (OFF) for D1, power turn-on (ON) for D2, remaining in current power state (NONE) for D3, power turn-off (OFF) for D4”.

Please refer also to the following table, the switch time sequences of the four scene modes are listed.

electronic appliance

| time | switch action | D1 | D2 | D3 | D4 |
|---|---|---|---|---|---|
| T1 | enabling M1 | ON | ON | NONE | ON |
| T2 | enabling M2 | ON | ON | ON | ON |
| T3 | enabling M3 | ON | OFF | ON | ON |
| T4 | enabling M4 | OFF | ON | ON | OFF |
| T5 | disabling M4 | OFF | OFF | ON | OFF |
| T6 | disabling M2 | OFF | OFF | ON | OFF |

For the ease of description, M1-M4 are used to express the first scene mode to the fourth scene mode, and D1-D4 are used to express the first electronic appliance to the fourth electronic appliance in the following. If the aforementioned table is described by time sequence, the switch order for the scene modes in the embodiment will be: enabling M1 at time T1, then enabling M2 at time T2, then enabling M3 at time T3, then enabling M4 at time T4, then disabling M4 at time T5, and then disabling M2 at time T6.

As shown in the table, when M1 is enabled at time T1, the application 10 turns on the power state of D1, D2 and D4 (as indicated ON) and remains the power state of D3 (as indicated NONE) according to the configuration of M1.

When M2 is enabled at time T2, the application 10 turns on the power states of D1, D3 and D4 (as indicated ON) and remains the power state of D2 (remained in the previous state “ON”) according to the configuration of M2. Next, the application 10 compares the current power states of D1-D4 with the configuration of M1.

Since the current power states of D1, D4 are identical to the configuration of M1 (ON) thus D1 and D4 do not have the power state conflict issue. Since M2 remains the power state of D2 (the power state of D2 remains in the previous state ON) thus D2 does not have the power state conflict issue either. Though M2 turns on the power state of D3, the power state of D3 configured in M1 is remaining in current power state (NONE), thus D3 does not have the power state conflict issue either.

When M3 is enabled at time T3, the application 10, according to the configuration of M3, turns off the power state of D2 (as indicated OFF), turns on the power state of D3 (as indicated ON), and remains the power states of D1 and D4 (remained in the power state at time T2, i.e. D1 is ON, D4 is ON). Next, the application 10 compares the current power states of D1-D4 with the configurations of both M1 and M2.

After comparison, the application 10 may determine that current power state of D2 (which is OFF) has a power state conflict issue with the configuration of M1 (indicated as ON). At this condition, M3 has the highest priority and thus the application 10 may still turn off the power state of D2 by transmitting the control signal, and then displays a message indicating “D2 has a power state conflict issue” on a column corresponding to M1 on the mobile device 1.

It should be noted that the application 10 in other embodiments may also display the name of the electronic appliance having the conflict issue and the name of the scene mode conflicting with the scene mode having the highest priority simultaneously. For example, the application 10 may display a message indicating “D2 has a power state conflict issue in M1” on a column corresponding to M3, but not limited thereto.

When M4 is enabled at time T4, the application 10, according to the configuration of M4, turns off the power states of D1 and D4 (as indicated OFF), turns on the power state of D2 (as indicated ON), and remains the power state of D3 (remained in the power state at time T3, i.e. D3 is ON). Next, the application 10 compares the current power states of D1-D4 with the configurations of M1, M2 and M3.

After comparison, the application 10 may determine that the current power state of D1 (which is OFF) has power state conflict issues with the configurations of M1 and M2 (both indicated as ON). At this condition, M4 has the highest priority and thus the application 10 may still turn off the power state of D1 by transmitting the control signal, and then displays the message indicating “D1 has power state conflict issues” on columns respectively corresponding to M1 and M2 on the mobile device 1. In additional, the application 10 also may determine that the power state of D2 (which is ON) has a power state conflict issue with the configuration of M3 (indicated as OFF). At this condition, M4 has the highest priority and thus the application 10 may still turn on the power state of D2 by transmitting the control signal, and then displays the message indicating “D2 has a power state conflict issue” on a column corresponding to M3 on the mobile device 1.

Besides, the application 10 also may determine that the current power state of D4 (which is OFF) has power state conflict issues with the configurations of M1 and M2 (both indicated as ON). At this condition, M4 has the highest priority and thus the application 10 may still turn off the power state of D4 by transmitting the control signal, and then displays the message indicating “D4 has power state conflict issues” on columns respectively corresponding to M1 and M2 on the mobile device 1.

When M4 is disabled in time T5, the application 10 reconfigures the sub-highest scene mode M3 as the scene mode having the highest priority. As described in the step S58 to the step S62 of FIG. 9A, the power state of D2 is configured as ON in the disabled M4, the current power state of D2 is ON, and the conflict issue may not occur with the configuration of M3 even if the power state of D2 is automatically turned off, thus the application 10 may perform the restoration operation on D2 through the restoration signal, so as to turn off the power state of D2 automatically.

Besides, the power states of D1 and D4 are configured as OFF in the disabled M4, which means the power states of D1 and D4 should be OFF after the M4 is enabled. If the user once turned on the power states of D1 and/or D4 through other interfaces or controllers, the application 10 may determine that the current power states of D1 and/or D4 differ from the configuration of the disabled M4 after the comparison in the step S58. Under this circumstance, the application 10 may perform the restoration operation to D1 and/or D4 according to the restoration signal after the M4 is disabled (i.e., at time T5), so as to turn off the power state of D1 and/or D4 automatically (however, the restoration operation shouldn't conflict with the configuration of M3).

Next, the application 10, according to the configuration of M3, regenerates a new control signal to turn on the power state of D3 (as indicated ON) (under such circumstance that D3 had been turned off through other interfaces or controllers), and remains the power states of D1, D4 (remained in the power state at time T4, i.e. D1 is OFF, D4 is OFF). Next, the application 10 compares the current power states of D1-D4 with the configurations of the rest enabled scene modes M1 and M2.

After comparison, the application 10 may determine that the current power state of D1 (which is OFF) has power state conflict issues with the configurations of M1 and M2 (both indicated as ON), and thus displays the message indicating “D1 has power state conflict issues” on columns respectively corresponding to M1 and M2 on the mobile device 1. In additional, the application 10 also may determine that the current power state of D2 (which is OFF) has a power state conflict issue with the configuration of M1 (indicated as ON), and thus displays the message indicating “D2 has a power state conflict issue” on the column corresponding to M1 on the mobile device 1. Besides, the application 10 also may determine that the current power state of D4 (which is OFF) has power state conflict issues with the configurations of M1 and M2 (both indicated as ON), and thus displays the message indicating “D4 has power state conflict issues” on columns respectively corresponding to M1 and M2 on the mobile device 1.

When M2 is disabled at time T6, though M2 is not the scene mode have the highest priority, the application 10 still needs to compare the disabled scene mode M2, the scene mode currently having the highest priority M3, and the current power state of each electronic appliance 3, so as to determine if it is necessary to automatically turn off any of the electronic appliances 3 according to the disabled M2, and also determine if any of the electronic appliances 3 has a power state conflict issue.

After comparison, the application 10 may determine that the current power state of D1 (which is OFF) has a power state conflict issue with the configuration of M1 (indicated as ON), and thus displays the message indicating “D1 has a power state conflict issue” on the column corresponding to M1 on the mobile device 1. In additional, the application 10 also may determine that the current power state of D2 (which is OFF) has a power state conflict issue with the configuration of M1 (indicated as ON), and thus displays the message indicating “D2 has a power state conflict issue” on the column corresponding to M1 on the mobile device 1. Besides, the application 10 also may determine that the current power state of D4 (which is OFF) has a power state conflict issue with the configuration of M1 (indicated as ON), and thus displays the message indicating “D4 has a power state conflict issue” on the column corresponding to M1 on the mobile device 1.

By using the displaying method of the present invention, the user may easily know whether any of the electronic appliances 3 has a power state conflict issue from the screen of the mobile device 1 when enabling/disabling each of the scene modes, so as to decide whether to enable/disable any scene mode or not.

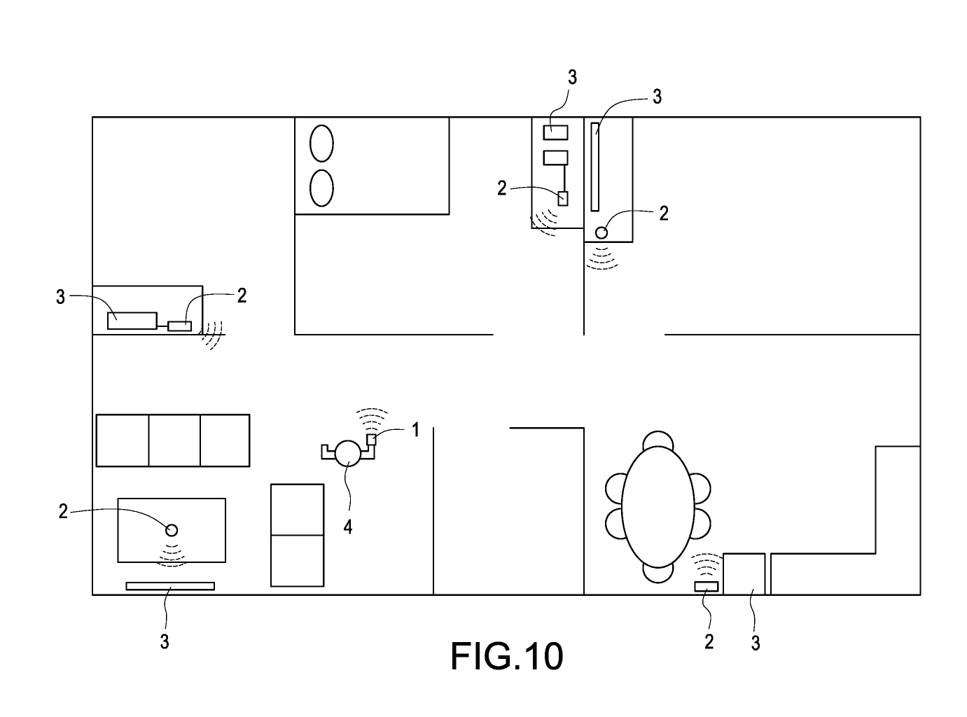

Refer to FIG. 10, which shows a diagram of a switching system according to the second embodiment of the present invention.

The switching system of the present invention may include a plurality of controllers 2, and an application 10 installed and executed in the mobile device 1. As shown in FIG. 10, the plurality of controllers 2 may be located at different areas to control the plurality of electronic appliances 3 at different areas.

In the embodiment, each scene mode may encompass more than one electronic appliance 3 respectively located at different areas. For example, a TV mode may encompass the TV, the loudspeaker and the table lamp located in the living room (i.e., the living room is controlled by the TV mode), and a reading mode may encompass the loudspeaker and the table lamp located in the study room (i.e., the study room is controlled by the reading mode). In other words, the plurality of scene modes configured by the application 10 may be regional.

In the embodiment, the application 10 may display reminders on the screen of the mobile device 1 to request the user 4 for disabling a particular scene mode of the multiple scene modes when the user 4 (i.e. the owner of the mobile device 1) leaves a particular region controlled by the particular scene mode. At this condition, the user 4 may choose to maintain the particular scene mode enabled, or choose to disable the particular scene mode. Alternatively, the application 10 may automatically disable the particular scene mode whenever the user 4 leaves the particular region controlled by the particular scene mode (such as automatically disabling the aforementioned TV mode when the user 4 leaves the living room). Besides, the application 10 may, after disabling the particular scene mode, reconfigures the highest priority for other enabled scene modes, perform the restoration operation to part or all of the electronic appliances 3, and regenerate and retransmit the control signal.

On the other side, the application 10 may display reminders on the screen of the mobile device 1 to request the user 4 for enabling a particular scene mode when the user 4 enters a particular region controlled by the particular scene mode. At this condition, the user 4 may choose to enable the particular scene mode, or choose to maintain the particular scene mode disabled. Alternatively, the application 10 may automatically enable the particular scene mode whenever the user 4 enters the particular region controlled by the particular scene mode (such as automatically enabling the aforementioned reading mode when the user 4 enters the study room). Besides, the application 10 may, after enabling the particular scene mode, reconfigures the particular scene mode as the scene mode having the highest priority, and then regenerates and retransmits the control signal.

In this way, the present invention may allow the user 4 to interact with the switching system. It should be noted that the controller 2 may control the power state of the electronic appliance 3, and also other parameters (such as the volume of the loudspeaker, the brightness of the table lamp, the source signal of the TV, etc.) of the electronic appliance 3. The control signal generated and transmitted by the application 10 may include not only the command for modifying the power state of the electronic appliance 3, and but also other parameters of the electronic appliance 3.

For example, when the user 4 enters the living room, the application 10 may enable a first TV mode corresponding to the plurality of electronic appliances 3 in the living room, wherein the configuration of the first TV mode indicates “TV power turn-on”, “loudspeaker power turn-on” and “adjusting volume of the loudspeaker to 5”. When the user 4 leaves the living room and enters the bedroom, the application 10 may disable the first TV mode and enables a second TV mode corresponding to the plurality of electronic appliances 3 in the bedroom. Besides, the application 10 may, through the control signal, turn on the TV and loudspeaker in the bedroom, and simultaneously adjusts the volume of the loudspeaker in the bedroom to 5.

For another example, when the user 4 enters the living room, the application 10 may enable a first music mode corresponding to the first loudspeaker in the living room, wherein the configuration of the first music mode indicates “first loudspeaker power turn-on”. Besides, the mobile device 1 may receive and wirelessly transmit online music stream to the first loudspeaker for playback. When the user 4 leaves the living room and enters the study room, the application 10 may disable the first music mode and enable a second music mode corresponding to the second loudspeaker in the study room. Besides, the application 10 may wirelessly transmit, automatically or manually by the user 4, the online music stream received by the mobile device 1 to the second loudspeaker for playback.

By the technical scheme mentioned above, the user 4 may use the same or similar scene modes at different areas continuously and conveniently.

It should be noted that, the plurality of controllers 2 in the switching system may be used to detect the area where the user 4 is located. For example, the application 10 may determine that the user 4 is currently in the living room when the mobile device 1 is successfully connected to the controller 2 located in the living room. When the mobile device 1 is disconnected from the controller 2 in the living room, and connected to another controller 2 located in the bedroom, the application 10 may determine that the user 4 is currently in the bedroom, and so on.

The switching system and displaying method of the present invention allow the user to simultaneously control the power states of the plurality of electronic appliances by the scene modes. When the user simultaneously enables multiple scene modes and this action results in the power state conflict issues of the electronic appliances, the user may also know the state conflict message by the present invention to effectively manage the conflict issues.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A state conflict displaying method used for a mobile device, comprising:
(a) enabling one of a plurality of preset scene modes, wherein a configuration of each scene mode respectively indicates power states of a plurality of electronic appliances connected to the mobile device;
(b) configuring the scene mode enabled in step (a) to have a highest priority and moving the scene mode with the highest priority to a first rank on a scene list displayed by the mobile device;
(c) generating and transmitting a control signal according to the configuration of the scene mode having the highest priority, wherein the control signal is used to control the power state of each of the electronic appliances;
(d) comparing the current power state of each of the electronic appliances with the configurations of other previously enabled scene modes to determine whether any of the electronic appliances has a power state conflict issue; and
(e) displaying a name of one of the electronic appliances on the mobile device when the one of the electronic appliances is determined having the power state conflict issue.

2. The state conflict displaying method of claim 1, wherein the power state at least comprises power turn-on, power turn-off and remaining in current power state.

3. The state conflict displaying method of claim 2, wherein step (d) is to determine that the one of the electronic appliances has the power state conflict issue when the current power state of the electronic appliance differs from the power state of the electronic appliance configured in any one of the previously enabled scene modes.

4. The state conflict displaying method of claim 2, wherein step (d) is to determine that the one of the electronic appliances has the power state conflict issue when the current power state of the electronic appliance is power turn-on, and the power state of the electronic appliance configured in any one of the previously enabled scene modes is power turn-off.

5. The state conflict displaying method of claim 2, wherein step (d) is to determine that the one of the electronic appliances has the power state conflict issue when the current power state of the electronic appliance is power turn-off, and the power state of the electronic appliance configured in any one of the previously enabled scene modes is power turn-on.

6. The state conflict displaying method of claim 2, further comprising following steps before step (a):
(a01) enabling a scene-mode setting function of the mobile device;
(a02) creating or choosing one of the scene modes;
(a03) setting or modifying the name of the scene mode;
(a04) providing a name list indicating the plurality of electronic appliances to be controlled;
(a05) choosing one or more of the electronic appliances and designating the power state of each chosen electronic appliance according to the name list; and
(a06) storing the power state of each of the electronic appliances as the configuration of the scene mode created or chosen in step (a02).

7. The state conflict displaying method of claim 2, wherein step (e) is to display the name of the electronic appliance having the power state conflict issue on a column of the scene list corresponding to another scene mode that conflicts with the scene mode having the highest priority.

8. The state conflict displaying method of claim 2, wherein step (b) is to add the scene mode enabled in step (a) to a top of a mode stack, to configure the scene mode at the top of the mode stack to have the highest priority, and to move the scene mode at the top of the mode stack to the first rank of the scene list.

9. The state conflict displaying method of claim 8, further comprising steps of:
(g) disabling one of the plurality of scene modes;
(h) determining whether the scene mode disabled in step (g) is the scene mode having the highest priority;
(i) if the scene mode disabled in step (g) has the highest priority, removing the disabled scene mode from the mode stack, and reconfiguring the scene mode currently at the top of the mode stack to have the highest priority;
(j) moving the scene mode currently having the highest priority to the first rank of the scene list following step (i);
(k) retrieving and comparing the configuration of the disabled scene mode, the configuration of the scene mode currently having the highest priority, and the current power state of each electronic appliance;
(l) generating a closing list according to the comparison result of step (k), wherein the closing list indicating one or more electronic appliances needed to be turned off automatically;
(m) generating and transmitting a restoration signal according to the closing list for turning off the power state of the one or more corresponding electronic appliances;
(n) regenerating and transmitting the control signal according to the configuration of the scene mode currently having the highest priority following step (m); and
(o) performing step (k), step (l), and step (m) if the scene mode disabled in step (g) is not the scene mode having the highest priority.

10. The state conflict displaying method of claim 9, further comprising steps of:
(p) comparing the current power state of each of the electronic appliances with the configurations of other previously enabled scene modes to determine whether any of the electronic appliances has the power state conflict issue following step (n) or step (o); and
(q) displaying the name of one of the electronic appliances on the mobile device when the one of the electronic appliances is determined having the power state conflict issue.

11. A scene-mode switching system comprising:
a controller connected to a plurality of electronic appliances; and
an application program configured to be executed in a mobile device connected to the controller, wherein the mobile device performs following actions when executing the application program:
enabling one of a plurality of preset scene modes, wherein a configuration of each scene mode respectively indicates a power state of the plurality of electronic appliances;
configuring the enabled scene mode to have a highest priority and moving the scene mode having the highest priority to a first rank on a scene list displayed by the mobile device;
generating a control signal according to the configuration of the scene mode having the highest priority and transmitting the control signal to the controller, wherein the controller uses the control signal to control the power state of each of the electronic appliances;
comparing the current power state of each of the electronic appliances with the configurations of other previously enabled scene modes to determine whether any of the electronic appliances has a power state conflict issue; and
displaying a name of one of the electronic appliances on the mobile device when the one of the electronic appliances is determined having the power state conflict issue.

12. The scene-mode switching system of claim 11, wherein the power state at least comprises power turn-on, power turn-off and remaining in current power state.

13. The scene-mode switching system of claim 12, wherein the application program is configured to determine that the one of the electronic appliances has the power state conflict issue when the current power state of the electronic appliance differs from the power state of the electronic appliance configured in any one of the previously enabled scene modes.

14. The scene-mode switching system of claim 12, wherein the application program is configured to determine that the one of the electronic appliance has the power state conflict issue when the current power state of the electronic appliance is power turn-on, and the power state of the electronic appliance configured in any one of the previously enabled scene modes is power turn-off.

15. The scene-mode switching system of claim 12, wherein the application program is configured to determine that the one of the electronic appliances has the power state conflict issue when the current power state of the electronic appliance is power turn-off, and the power state of the electronic appliance configured in any one of the previously enabled scene modes is power turn-on.

16. The scene-mode switching system of claim 12, wherein the mobile device executes the application program to further perform actions of:
enabling a scene-mode setting function of the mobile device;
creating or choosing one of the scene modes;
setting or modifying the name of the scene mode;
providing a name list indicating the plurality of electronic appliances to be controlled;
choosing one or more of the electronic appliances and designating the power state of each chosen electronic appliance according to the name list; and
storing the power state of each of the electronic appliances as the configuration of the created or chosen scene mode.

17. The scene-mode switching system of claim 12, wherein the mobile device displays the name of the electronic appliance on a column of the scene list corresponding to a particular scene mode when the power state of the electronic appliance under the particular scene is conflicting with the power state of the electronic appliance under the scene mode having the highest priority.

18. The scene-mode switching system of claim 12, wherein the application program is configured to add the last enabled scene mode to a top of a mode stack, to configure the scene mode at the top of the mode stack to have the highest priority, and to move the scene mode at the top of the mode stack to the first rank of the scene list.

19. The scene-mode switching system of claim 18, wherein the mobile device executes the application program to perform actions of:
disabling one of the plurality of scene modes;
determining whether the disabled scene mode is the scene mode having the highest priority;
performing following actions when determining the disabled scene mode has the highest priority:
(1) removing the disabled scene mode from the mode stack, and reconfiguring the scene mode currently at the top of the mode stack to have the highest priority;
(2) moving the scene mode currently having the highest priority to the first rank of the scene list;
(3) retrieving and comparing the configuration of the disabled scene mode, the configuration of the scene mode currently having the highest priority, and the current power state of each electronic appliance;
(4) generating a closing list according to the comparison result of action (3), wherein the closing list indicating one or more electronic appliances needed to be turned off automatically;
(5) generating and transmitting a restoration signal according to the closing list of action (4) for turning off the power state of the one or more corresponding electronic appliances; and
(6) regenerating and transmitting the control signal according to the configuration of the scene mode currently having the highest priority following action (5); and
performing following actions when determining the disabled scene mode is not the scene mode having the highest priority:
(7) retrieving and comparing the configuration of the disabled scene mode, the configuration of the scene mode currently having the highest priority, and the current power state of each electronic appliance;
(8) generating a closing list according to the comparison result of action (7), wherein the closing list indicating one or more electronic appliances needed to be turned off automatically; and
(9) generating and transmitting a restoration signal according to the closing list of action (8) for turning of the power state of the one or more corresponding electronic appliances.

20. The scene-mode switching system of claim 19, wherein the mobile device executes the application program to perform actions of:
comparing the current power state of each of the electronic appliances with the configurations of other previously enabled scene modes to determine whether any of the electronic appliances has the power state conflict issue; and
displaying the name of one of the electronic appliances on the mobile device when the electronic appliance is determined having the power state conflict issue.
